(19) United States
(12) Patent Application Publication
(10) Pub. No.: US 2025/0036883 A1
(43) Pub. Date: Jan. 30, 2025

(54) CLUSTER LEARNING AND LARGE LANGUAGE MODEL FRAMEWORK

(71) Applicant: Dell Products L.P., Round Rock, TX (US)

(72) Inventor: Leandro Hattori, Campo Grande (BR)

(21) Appl. No.: 18/359,255

(22) Filed: Jul. 26, 2023

(51) Int. Cl. G06F 40/40

(52) U.S. Cl. CPC G06F 40/40

(57) ABSTRACT

A method comprises receiving a query comprising one or more parameters for cluster formation, and forming a plurality of clusters from an input dataset, wherein the plurality of clusters comprise respective ones of a plurality of sub-datasets of the input dataset and are based at least in part on the one or more parameters. A plurality of data points from respective ones of the plurality of clusters are selected, and one or more features from the plurality of data points are identified. The method further comprises inputting the one or more features to a machine learning language model, and executing the machine learning language model to generate a textual output based at least in part on the one or more features.

### FIELD

The field relates generally to information processing systems, and more particularly to cluster analysis in information processing systems.

### BACKGROUND

Cluster analysis, or simply clustering, groups a set of objects (e.g., data objects) such that objects in the same group (cluster) are more similar to each other in one or more aspects than to those in other groups. Clustering may be used for exploratory and/or statistical data analysis to, for example, recognize patterns, analyze images, retrieve information, compress data and perform machine learning.

Clustering is a technique that permits discovery of hidden patterns in data. However, understanding the results of clustering can be challenging, as it is often difficult to interpret the relationships between the elements of a cluster and the features that contribute to its formation. This lack of comprehensibility can limit the practical usefulness of clustering techniques.

### SUMMARY

Embodiments provide a cluster learning and large language model (LLM) platform in an information processing system.

For example, in one embodiment, a method comprises receiving a query comprising one or more parameters for cluster formation, and forming a plurality of clusters from an input dataset, wherein the plurality of clusters comprise respective ones of a plurality of sub-datasets of the input dataset and are based at least in part on the one or more parameters. A plurality of data points from respective ones of the plurality of clusters are selected, and one or more features from the plurality of data points are identified. The method further comprises inputting the one or more features to a machine learning language model, and executing the machine learning language model to generate a textual output based at least in part on the one or more features.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a cluster learning and LLM platform in an illustrative embodiment.

FIG. 2 depicts example cluster data sources according to an illustrative embodiment.

FIG. 3 depicts an operational flow for cluster analysis and textual output based on the analysis in an illustrative embodiment.

FIG. 4 depicts an example structure for an input prompt to a machine learning language model in an illustrative embodiment.

FIG. 5 depicts a process for cluster analysis and textual output generation according to an illustrative embodiment.

FIGS. 6 and 7 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

As used herein, “natural language” is to be broadly construed to refer to any language that has evolved naturally in humans. Non-limiting examples of natural languages include, for example, English, Spanish, French and Hindi.

As used herein, “natural language processing (NLP)” is to be broadly construed to refer to interactions between computers and human (natural) languages, where computers are able to derive meaning from human or natural language input, and respond to requests and/or commands provided by a human using natural language.

As used herein, “natural language understanding (NLU)” is to be broadly construed to refer to a sub-category of natural language processing in artificial intelligence where natural language input is disassembled and parsed to determine appropriate syntactic and semantic schemes in order to comprehend and use languages. NLU may rely on computational models that draw from linguistics to understand how language works, and comprehend what is being said by a user.

As used herein, “natural language generation (NLG)” is to be broadly construed to refer to a computer process that transforms data into natural language. For example, NLG systems decide how to put concepts into words. NLG can be accomplished by training machine learning models using a corpus of human-written texts.

As used herein, “application programming interface (API)” or “interface” refers to a set of subroutine definitions, protocols, and/or tools for building software. Generally, an API defines communication between software components. APIs permit programmers to write software applications consistent with an operating environment or website. APIs are used to integrate and pass data between applications, and may be implemented on top of other systems.

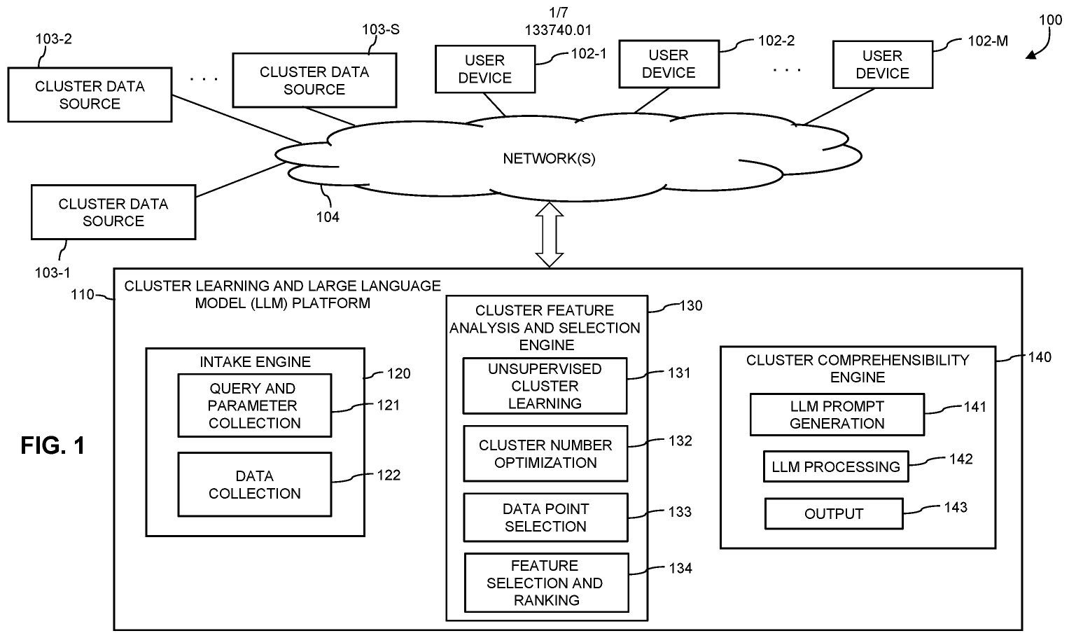

FIG. 1 shows an information processing system 100 configured in accordance with an illustrative embodiment. The information processing system 100 comprises user devices 102-1. 102-2, . . . 102-M (collectively “user devices 102”). The user devices 102 communicate over a network 104 with a cluster learning and large language model (LLM) platform 110. The variable M and other similar index variables herein such as K. L and S are assumed to be arbitrary positive integers greater than or equal to one.

The user devices 102 can comprise, for example, Internet of Things (IoT) devices, desktop, laptop or tablet computers, mobile telephones, or other types of processing devices capable of communicating with the cluster learning and LLM platform 110 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Cluster learning and LLM services may be provided for users utilizing one or more machine learning models, although it is to be appreciated that other types of infrastructure arrangements could be used. At least a portion of the available services and functionalities provided by the cluster learning and LLM platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the cluster learning and LLM platform 110, as well as to support communication between the cluster learning and LLM platform 110 and connected devices (e.g., user devices 102) and/or other related systems and devices not explicitly shown.

In some embodiments, the user devices 102 are assumed to be associated with repair technicians, system administrators, information technology (IT) managers, software developers, release management personnel or other authorized personnel configured to access and utilize the cluster learning and LLM platform 110. The user devices 102 can also be respectively associated with one or more customers requiring cluster analysis.

As noted hereinabove, there are technical problems with understanding the results of clustering, which can limit the practical usefulness of clustering techniques. For example, one of the challenges in generating comprehensibility in unsupervised problems is the high dimensionality of the data, which makes it difficult to identify the features that contribute most significantly to cluster information. Additionally, the lack of labeled data in unsupervised learning means that conventional metrics for evaluating model performance, such as precision and recall, cannot be used to assess the effectiveness of clustering algorithms. Addressing these challenges requires the development of new methods for feature selection and evaluation, as well as the creation of intuitive visualization tools that enable users to explore and understand the relationships between clusters and features.

In the current data-driven society, a significant portion of data is unlabeled, thereby requiring unsupervised learning approaches for data analysis. In this context, the embodiments provide techniques for data analysis in diverse areas including, but not necessarily limited to, management, marketing, commerce and IT. The embodiments advantageously leverage computational resources to combine unsupervised cluster learning (UCL) with LLMs (e.g., LLM microservices) to enhance the comprehensibility of UCL models.

In order to address the problems with current approaches, illustrative embodiments provide an automated framework for cluster analysis and generation of outputs explaining the results of the analysis. Advantageously, the illustrative embodiments provide techniques for cluster feature analysis and selection, and for cluster comprehensibility analysis. In more detail, in connection with cluster feature analysis and selection, UCL is applied to an input dataset using one or more unsupervised machine learning algorithms such as, but not necessarily limited to, a K-means algorithm. The number of clusters is optimized by identifying an elbow point on one or more performance metrics such as, but not necessarily limited to, silhouette score. After identifying the clusters, representative data points in each cluster are selected using, for example, silhouette scores. These data points are used in connection with statistical analysis to select the most relevant features of each cluster through statistical analysis. In connection with cluster comprehensibility analysis, a prompt comprising the selected features is inputted to an LLM, which generates a textual output based at least in part on the selected features. The textual output provides an explanation of the clusters based on their characteristics.

The embodiments advantageously combine UCL and LLM techniques to extract specific cluster metrics and features, which are used in the context of an LLM prompt to provide comprehensive explanations of clustered data.

The cluster learning and LLM platform 110 in the present embodiment is assumed to be accessible to the user devices 102 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCle) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the cluster learning and LLM platform 110 includes an intake engine 120, a cluster feature analysis and selection engine 130 and a cluster comprehensibility engine 140. The intake engine 120 includes a query and parameter collection layer 121 and a data collection layer 122. The cluster feature analysis and selection engine 130 includes an unsupervised cluster learning layer 131, a cluster number optimization layer 132, a data point selection layer 133 and a feature selection and ranking layer 134. The cluster comprehensibility engine 140 includes an LLM prompt generation layer 141, an LLM processing layer 142 and an output layer 153.

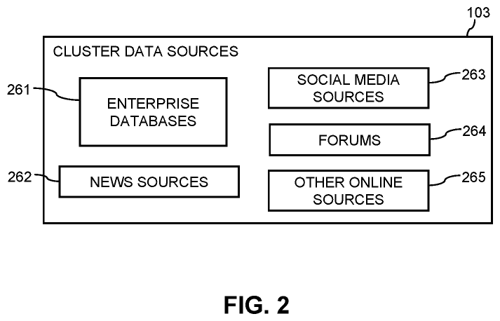

The query and parameter collection layer 121 of the intake engine 120 collects input queries and corresponding query parameters from one or more user devices 102. Based on the input queries and parameters, the data collection layer 122 collects data to be analyzed and clustered from one or more cluster data sources 103-1, 103-2, . . . 103-S(collectively “cluster data sources 103”). Referring to FIG. 2, in a non-limiting illustrative embodiment, the cluster data sources 103 comprise, for example, one or more of enterprise databases 261, news sources 262, social media sources 263, forums 264 and other online sources 265.

The query and parameter collection layer 121 of the intake engine 120 receives and processes, for example, a query received from, for example, a user device over the network 104, and comprising one or more parameters for cluster formation. The parameters comprise, for example, one or more designated characteristics to be included in an input dataset from which a plurality of clusters will be formed, where the plurality of clusters comprise respective ones of a plurality of sub-datasets of the input dataset. In some embodiments, the query and parameter collection layer 121 generates a user interface (e.g., graphical user interface (GUI)) for one or more of the user devices 102, which may be used by a user to input a query. A query may specify, for example, the types and characteristics of data being sought such as, but not necessarily limited to, user or customer behavior in connection with enterprise products or services, user or customer demographics, product or service features, product or service issues, technical support issues, product or service lifecycles, product components (e.g., hardware, software, firmware), product versions, models, marketing initiatives, etc. In some embodiments, the query and parameter collection layer 121 may include NLP and/or NLU capabilities to understand and parse the queries, and feed an output of the representative parameters of the query to the data collection layer 122, which collects data to form the input dataset based on the parameters from the cluster data sources 103.

In illustrative embodiments, using one or more automated scripts, the data collection layer 122 systematically searches (e.g., crawls) the network 104 comprising the cluster data sources 103 for data to form the input dataset based on the query parameters. For example, in connection with collecting data to form the input dataset that is to be input to the unsupervised cluster learning layer 131 of the cluster feature analysis and selection engine 130, the data collection layer 122 crawls the network 104 to collects data relevant to the query from, for example, one or more of enterprise databases 261, news sources 262, social media sources 263, forums 264 and other online sources 265.

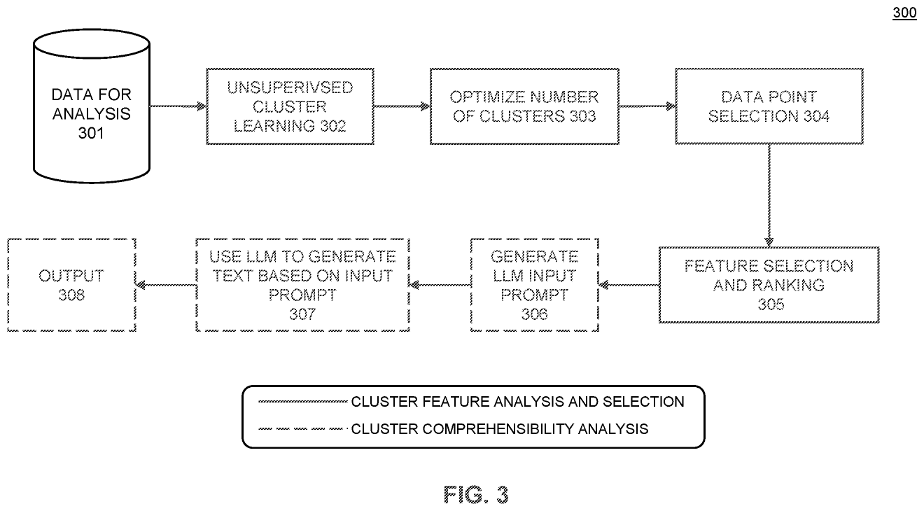

Referring to FIG. 1 and to the operational flow 300 in FIG. 3, the data for analysis 301 (e.g., input dataset) is transmitted to the unsupervised cluster learning layer 131 so that unsupervised cluster learning (block 302) can be performed to form a plurality of clusters from the input dataset. The plurality of clusters comprise respective ones of a plurality of sub-datasets of the input dataset and are based at least in part on the one or more query parameters. Referring to block 303, the cluster number optimization layer 132 optimizes the number of clusters. In more detail, a K-means clustering algorithm, which may be used in machine learning and data mining, partitions the data for analysis 301 into K clusters based on the similarity of the data points. The K value is determined based on, for example, an elbow curve method, which is used to optimize the number of clusters by identifying an elbow point on one or more performance metrics. The one or more performance metrics comprise, for example, a silhouette score, sum of squared distances (SSD) and/or within-cluster sum of squares (WSS).

K-means works by randomly selecting K centroids, and then assigning each data point to the nearest centroid. The centroids are then moved to the mean position of the data points in each cluster, and the process is repeated until convergence. In illustrative embodiments, cluster metrics are used to evaluate the quality of the clusters generated by clustering algorithms. As noted herein, the metrics that may be used include silhouette score, a sum of squared distances and/or a within-cluster sum of squares. Silhouette score measures the quality of a cluster based on the distance between the data points within a cluster and the distance between the data points in the nearest neighboring cluster. A high silhouette score indicates a well-defined cluster, while a low score indicates that the data points may belong to more than one cluster. SSD measures the total distance between the data points and their respective centroids, and WSS measures the total distance between the data points and their cluster centroids.

Based on an unsupervised cluster learning algorithm, such as K-means, the optimal number of clusters is determined by identifying the elbow point on a performance metric, such as a silhouette score, which can be supplemented by other cluster metrics.

The silhouette score, denoted as S, is a measure of the quality of clustering, ranging from −1 to 1. A higher silhouette score indicates that the samples within a cluster are like each other and dissimilar to samples in other clusters. The silhouette score is calculated for each sample in a cluster based on the average distance to other samples within the same cluster (aᵢ) and the average distance to samples in the nearest neighboring cluster (bᵢ). The formula (1) for the silhouette score is as follows:

$${S}_{i} = \frac{{b}_{i} - {a}_{i}}{max ( {a}_{i} , {b}_{i} )} \qquad ( 1 )$$

After the silhouette score calculation for each point in the cluster Kⱼ, referring to block 304 of the operational flow 300 in FIG. 3, the data point selection layer 133 selects the most representative points to perform the cluster analysis. The selecting of a plurality of representative data points from respective ones of a plurality of clusters is based at least in part on a threshold value for a number of the most representative data points in each cluster, and may comprise computing a silhouette score for respective ones of the plurality of data points.

In more detail, let P=argsort(S) from the most representative points to the least representative points in Kⱼ. Let Rᵣₑₚ(Kⱼ) denote the set of most relevant points in cluster Kⱼ based on chosen quality metrics, such as, for example, the top-s points with the highest silhouette scores in each cluster, or the top-n points nearest to the centroid of the cluster. The selection of Rᵣₑₚ(Kⱼ) is determined by delimiting based on a threshold value τᵣ, where τ_{r,j} represents the threshold value for the cluster Kⱼ. This threshold value represents a criterion to filter data points that may not be sufficiently representative to the cluster. The higher the value of τ_{r,j}, the more important the points in cluster Kⱼ are considered, in this example τᵣ>0, this can be represented by formula (2) as:

$${R}_{r e p} ( {K}_{j} ) = \{ p ∈ {K}_{j} : P ( {p}_{i} ) \geq {τ}_{r , j} \} \qquad ( 2 )$$

Alternatively, a percentage of points can be chosen, for example, α percentage of the most relevant points in a cluster Kⱼ, which can be demonstrated by formula (3) as:

$${R}_{r e p} ( {K}_{j} ) = \{ p ∈ {K}_{j} : P ( {p}_{i} ) \geq α \cdot max ( {P}_{i} ) \} \qquad ( 3 )$$

Referring to block 305 of the operational flow 300, the feature selection and ranking layer 134 performs feature selection and ranking. For example, one or more features from the plurality of representative data points are selected by executing a coefficient of variation analysis on a base set of features derived from the representative data points. Respective ones of the features from the base set are ranked based at least in part on a coefficient of variation of the respective ones of the features.

In more detail, with the most representative points R, the most relevant features for the most representative points are extracted using statistical analysis from one or more feature selection approaches. For example, letting F represent the set of features of R, the mean of feature f∈F for the cluster Kⱼ is denoted as μ_{f,R} and the standard deviation as σ_{f,R}. The coefficient of variation CV of feature f∈F for the cluster Kᵢ is computed according to formula (4) as:

$$C {V}_{f , R} = \frac{{σ}_{f , R}}{{μ}_{f , R}} \qquad ( 4 )$$

Then, the features are ranked based on their CV values, and the features with the lowest CV values (e.g., lowest variation from each other) are selected, denoted as F_{CV}_{ₘᵢₙ}⊆F. Alternatively, or additionally, the features with the highest CV values are selected to indicate variability, which may identify diversity between features F_{CV}_{ₘₐₓ}⊆F.

Blocks 301-305 of the operational flow correspond to cluster feature analysis and selection, and remaining blocks 306-308 correspond to cluster comprehensibility analysis. For example, referring to block 306, the LLM prompt generation layer 141 of the cluster comprehensibility engine 140 generates an LLM input prompt comprising the selected features, which is input to a machine learning language model such as, for example, an LLM. In addition to comprising the selected features, the LLM prompt specifies a standard deviation value and a mean value associated with the selected features, and comprises a cluster density value and/or cluster compactness value.

In more detail, in illustrative embodiments, the machine learning language model (e.g., LLM) comprises a trained neural network capable of using NLG techniques to generate coherent and relevant human-like text (e.g., natural language) from a given prompt. In illustrative embodiments, the LLM is trained and re-trained (e.g., through a feedback loop based on the accuracy of the output) on massive amounts of data to learn to identify patterns and relationships within text, allowing it to generate high-quality output. With its ability to understand and produce human-like language, the LLM of the illustrative embodiments is used in NLP applications, and provides a powerful tool to enhance the comprehensibility of unsupervised clustering models.

In the context of NLP, the input prompt comprises text that serves as an input for the machine learning language model to generate a corresponding output. The prompt comprises one or more instructions given to the model that guides it in producing a relevant and coherent response. In the illustrative embodiments, the prompt serves as a crucial component in generating explanations for the clusters obtained through unsupervised cluster learning. By generating a prompt based on the context input and selected features and inputting the prompt to a machine learning language model, the machine learning language model can generate a description of the cluster characteristics, which can be used to label the clusters and provide a comprehensible explanation of the clusters.

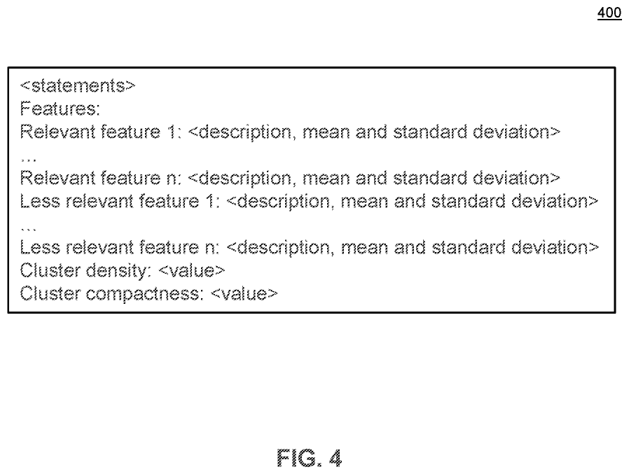

The selected features of the most relevant points from a given cluster or a plurality of clusters are the basis of the input prompt. As shown in the example prompt structure 400 in FIG. 4, a given prompt includes description of one or more features determined to be relevant and one or more features determined to be less relevant along with their corresponding mean and standard deviation values (e.g., the mean value for F_{CV}_{ₘᵢₙ}, and the mean and deviation for the F_{CV}_{ₘₐₓ}). The mean value indicates the central tendency of the data, while the standard deviation represents how spread out the data points are from the mean. In addition, as shown in the prompt structure 400 of FIG. 4, the prompt may further include additional overall internal cluster metrics to weight the tone of the output text. For instance, cluster density and compactness are two such metrics that can be used. By incorporating these metrics into the machine learning language model (e.g., LLM) prompt, the embodiments advantageously provide techniques to identify nuances such as, for example, how well-defined the determined relevant data points are in relation to the total data points of the cluster.

Cluster density refers to the proportion of data points that are assigned to a cluster and can be defined as the average number of points per unit of volume in a cluster, and can be calculated using the following equation (5):

$$Density = n / V \qquad ( 5 )$$

where n is the number of points in the cluster, and V is the volume of the cluster.

Compactness, on the other hand, measures how closely the points in the cluster are packed together (e.g., how close the data points within a cluster are to each other), and can be calculated as the average distance of the selected features for all points in the cluster using the following equation (6):

$$Compactness = ( 1 / n ) * {\sum }_{i = 1}^{n} {( distance ( {x}_{i} , c ) )}^{2} \qquad ( 6 )$$

where xᵢ is the feature vector of the i-th point, c is the centroid of the cluster, and distance(xi, c) is the distance between xᵢ and c. These metrics can be used to add more context and detail to the generated text, providing a more comprehensive explanation of the characteristics of the cluster.

Referring to blocks 307 and 308 of the operational flow 300 in FIG. 3, the LLM processing layer 142 uses the LLM (or other machine learning language model) to generate text based on the input prompt (e.g., the selected features and other criteria). The output layer 143 outputs the generated text to one or more user devices 102 over the network 104 in response to an incoming query. The output 308 may be generated as a real-time response to a given query.

In an operational example, an enterprise (e.g., a large multinational corporation) with a diverse customer base (e.g., millions of customers worldwide) wants to understand their customers better and tailor their marketing and product strategies to meet their needs. However, with millions of customers worldwide, it can be practically impossible to identify patterns and similarities between the customers. In an effort to address this problem, the embodiments provide techniques to use unsupervised clustering techniques to segment customers based on their behavior, needs, and preferences to enable the enterprise to identify distinct customer groups with similar characteristics.

However, as noted herein above, understanding the characteristics of each cluster can be challenging. The embodiments advantageously provide techniques to identify features from the clusters and use those identified features in an input prompt to a machine learning language model in order to a generate a textual output that provides insights into what distinguishes each group from the others.

For example, a user (e.g., enterprise employee) may generate a query seeking a personalized brand recommendation and prescription to offer to a specific segment of clients of the enterprise, and to understand the rationale behind the recommendation. In this case, an input prompt to an LLM may be generated as follows:

### Features:

Relevant feature 1: Age, standard deviation: 0.8 and mean: 30 years-old;
Relevant feature 2: Income, standard deviation: $20 and mean: $100,000 per year;
Less relevant feature 1: Time spent on social media, standard deviation: 10.2 and mean: 2.5 hours per day;
Less relevant feature 2: Annual vacation days, standard deviation: 10.0 and mean: 10 days;
Cluster density: 0.5;
Cluster compactness: 0.3.

Based on the above prompt, which can be generated using the above-described techniques, the natural language output may recite, for example: “The recommendation is to offer Enterprise X's gaming laptops to this segment of clients because this cluster has a relatively young age demographic with a higher income level, indicating an interest in technology and entertainment. The less relevant feature of spending time on social media could also suggest an interest in gaming and digital entertainment. Additionally, the compactness of this cluster suggests that this recommendation would be relevant to a large proportion of this segment. To make this recommendation more personal, offering a prescription for a specific Type A gaming laptop would suit the needs of this cluster. Based on their income level, a higher-end model such as Model ABC123 would be appropriate. These laptops offer top-of-the-line gaming performance and impressive graphics capabilities, making them a great choice for gamers or anyone interested in high-performance computing.”

In some embodiments, data sources, data corpuses, repositories or databases referred to herein are implemented using one or more storage systems or devices associated with the cluster learning and LLM platform 110. In some embodiments, one or more of the storage systems utilized to implement the data sources, data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the cluster learning and LLM platform 110, the intake engine 120, cluster feature analysis and selection engine 130 and/or cluster comprehensibility engine 140 in other embodiments can be implemented at least in part externally to the cluster learning and LLM platform 110, for example, as stand-alone servers, sets of servers or other types of systems coupled to the network 104. For example, the intake engine 120, cluster feature analysis and selection engine 130 and/or cluster comprehensibility engine 140 may be provided as cloud services accessible by the cluster learning and LLM platform 110.

The intake engine 120, cluster feature analysis and selection engine 130 and/or cluster comprehensibility engine 140 in the FIG. 1 embodiment are each assumed to be implemented using at least one processing device. Each such processing device generally comprises at least one processor and an associated memory, and implements one or more functional modules for controlling certain features of the intake engine 120, cluster feature analysis and selection engine 130 and/or cluster comprehensibility engine 140.

At least portions of the cluster learning and LLM platform 110 and the elements thereof may be implemented at least in part in the form of software that is stored in memory and executed by a processor. The cluster learning and LLM platform 110 and the elements thereof comprise further hardware and software required for running the cluster learning and LLM platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the intake engine 120, cluster feature analysis and selection engine 130, cluster comprehensibility engine 140 and other elements of the cluster learning and LLM platform 110 in the present embodiment are shown as part of the cluster learning and LLM platform 110, at least a portion of the intake engine 120, cluster feature analysis and selection engine 130, cluster comprehensibility engine 140 and other elements of the cluster learning and LLM platform 110 in other embodiments may be implemented on one or more other processing platforms that are accessible to the cluster learning and LLM platform 110 over one or more networks. Such elements can each be implemented at least in part within another system element or at least in part utilizing one or more stand-alone elements coupled to the network 104.

It is assumed that the cluster learning and LLM platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the intake engine 120, cluster feature analysis and selection engine 130, cluster comprehensibility engine 140 and other elements of the cluster learning and LLM platform 110, and the elements thereof can each be implemented in the form of one or more LXCs running on one or more VMs. Other arrangements of one or more processing devices of a processing platform can be used to implement the intake engine 120, cluster feature analysis and selection engine 130 and cluster comprehensibility engine 140, as well as other elements of the cluster learning and LLM platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the cluster learning and LLM platform 110 to reside in different data centers. Numerous other distributed implementations of the cluster learning and LLM platform 110 are possible.

Accordingly, one or each of the intake engine 120, cluster feature analysis and selection engine 130, cluster comprehensibility engine 140 and other elements of the cluster learning and LLM platform 110 can each be implemented in a distributed manner so as to comprise a plurality of distributed elements implemented on respective ones of a plurality of compute nodes of the cluster learning and LLM platform 110.

It is to be appreciated that these and other features of illustrative embodiments are presented by way of example only, and should not be construed as limiting in any way. Accordingly, different numbers, types and arrangements of system elements such as the intake engine 120, cluster feature analysis and selection engine 130, cluster comprehensibility engine 140 and other elements of the cluster learning and LLM platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the cluster learning and LLM platform can be offered to cloud infrastructure customers or other users as part of FaaS, CaaS and/or PaaS offerings.

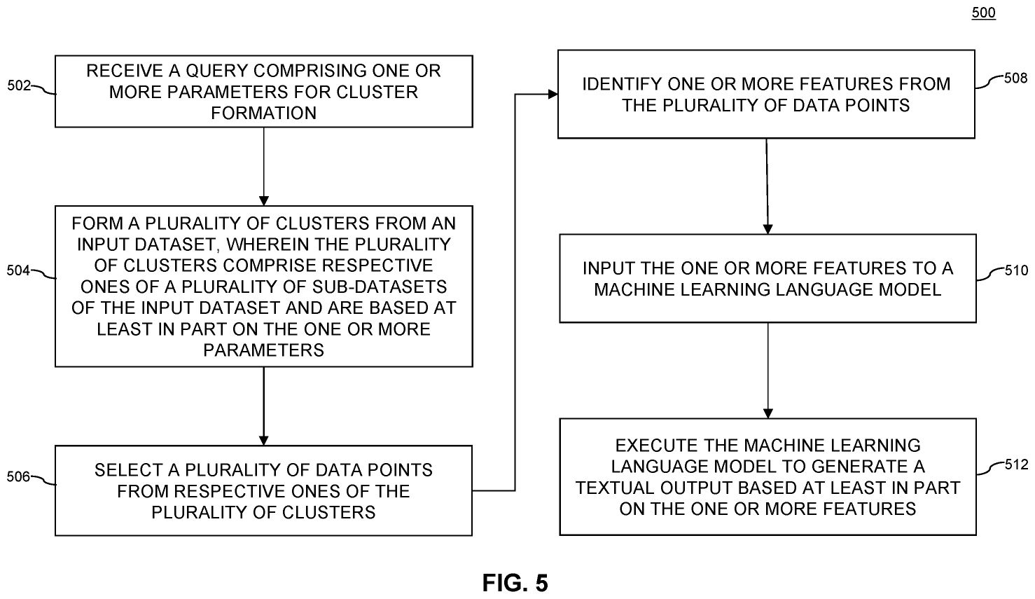

The operation of the information processing system 100 will now be described in further detail with reference to the flow diagram of FIG. 5. With reference to FIG. 5, a process 500 for cluster analysis and textual output generation as shown includes steps 502 through 512, and is suitable for use in the system 100 but is more generally applicable to other types of information processing systems comprising a cluster learning and LLM platform configured for cluster analysis and textual output generation.

In step 502, a query comprising one or more parameters for cluster formation is received. The one or more parameters comprise, for example, one or more designated characteristics to be included in the input dataset.

In step 504, a plurality of clusters is formed from an input dataset, wherein the plurality of clusters comprise respective ones of a plurality of sub-datasets of the input dataset and are based at least in part on the one or more parameters. Forming the plurality of clusters comprises executing one or more unsupervised machine learning algorithms on the input dataset to form the plurality of clusters. In an example embodiment, the one or more unsupervised machine learning algorithms comprise, for example, a K-means algorithm. Forming the plurality of clusters comprises optimizing a number of the plurality of clusters by identifying an elbow point on one or more performance metrics for the plurality of clusters. The one or more performance metrics comprise at least one of a silhouette score, a sum of squared distances, and a within-cluster sum of squares.

In step 506, a plurality of data points is selected from respective ones of the plurality of clusters. Selecting the plurality of data points from respective ones of the plurality of clusters is based at least in part on a threshold value for a number of representative data points from each of the respective ones of the plurality of clusters. Selecting the plurality of data points from respective ones of the plurality of clusters comprises computing a silhouette score for respective ones of the plurality of data points.

In step 508, one or more features are identified from the plurality of data points. Identifying of the one or more features from the plurality of data points may comprise executing a coefficient of variation analysis on a base set of features derived from the plurality of data points, and ranking respective ones of the features from the base set based at least in part on a coefficient of variation of the respective ones of the features.

In step 510, the one or more features are input to a machine learning language model. Inputting the one or more features to the machine learning language model comprises generating an input prompt for the machine learning language model, the input prompt comprising the one or more features and at least one of a standard deviation value and a mean value associated with the one or more features. The input prompt further comprises at least one of a cluster density value and cluster compactness value.

In step 512, the machine learning language model is executed to generate a textual output based at least in part on the one or more features. The machine learning language model comprises, for example, an LLM.

It is to be appreciated that the FIG. 5 process and other features and functionality described above can be adapted for use with other types of information systems configured to execute cluster analysis and textual output generation services in a cluster learning and LLM platform or other type of platform.

The particular processing operations and other system functionality described in conjunction with the flow diagram of FIG. 5 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 5 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a cluster learning and LLM platform as disclosed herein can provide a number of significant advantages relative to conventional arrangements. For example, the cluster learning and LLM platform advantageously leverages the power of UCL to extract specific cluster metrics and features, which are then used then in the context of a LLM prompt to automatically provide comprehensive summaries of clusters and analyzed data. Unlike conventional approaches, by optimizing the number of clusters and performing data and feature selection for inclusion in a prompt for a machine learning language model, the embodiments advantageously generate a natural language explanation of one or more clusters based on the results of UCL techniques. The embodiments facilitate cluster analysis by combining UCL and LLM techniques and using the results of UCL to generate an input prompt for LLM analysis.

As an additional advantage, the techniques of the illustrative embodiments use cluster metrics to select the most informative features of each cluster, which allows for the provision of accurate and contextual information to be used in connection with LLM prompt generation. By utilizing the techniques of the illustrative embodiments, challenges with interpretation of UCL results can be overcome so that reliable and useful outputs explaining and/or summarizing clusters are generated. The proposed approaches focus on comprehensibly of the cluster so that the outputs can be used by a wider range of users (e.g., users with less technical expertise) than conventional approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the cluster learning and LLM platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a cluster learning and LLM platform in illustrative embodiments. These and other cloud-based systems in illustrative embodiments can include object stores.

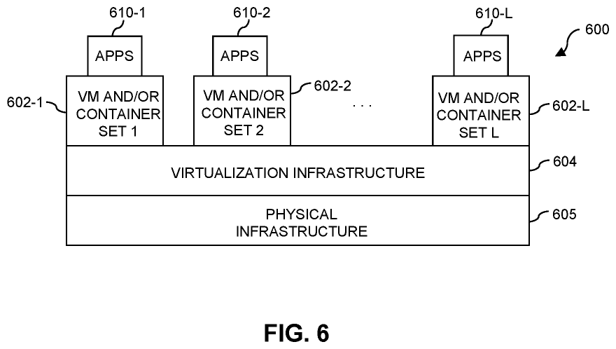

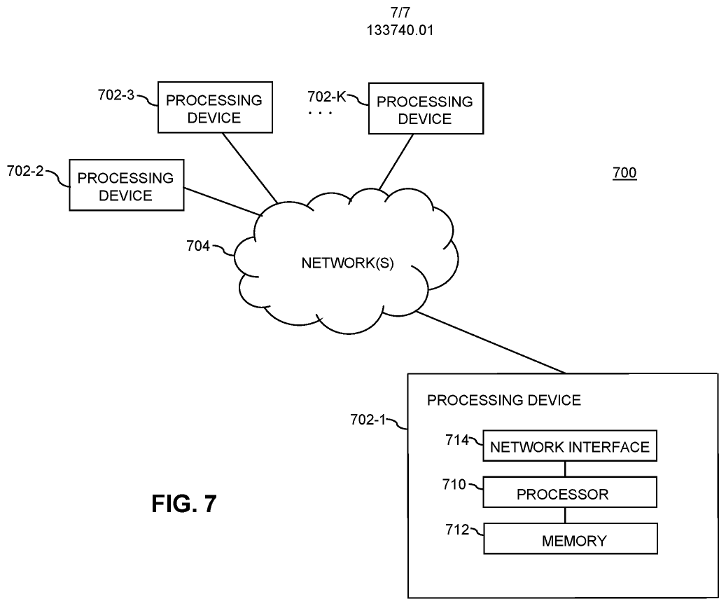

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712. The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the cluster learning and LLM platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and cluster learning and LLM platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a query comprising one or more parameters for cluster formation;
forming a plurality of clusters from an input dataset, wherein the plurality of clusters comprise respective ones of a plurality of sub-datasets of the input dataset and are based at least in part on the one or more parameters;
selecting a plurality of data points from respective ones of the plurality of clusters;
identifying one or more features from the plurality of data points;
inputting the one or more features to a machine learning language model; and
executing the machine learning language model to generate a textual output based at least in part on the one or more features;
wherein the steps of the method are executed by at least one processing device operatively coupled to a memory.

2. The method of claim 1 wherein forming the plurality of clusters comprises executing one or more unsupervised machine learning algorithms on the input dataset to form the plurality of clusters.

3. The method of claim 2 wherein the one or more unsupervised machine learning algorithms comprise a K-means algorithm.

4. The method of claim 1 wherein forming the plurality of clusters comprises optimizing a number of the plurality of clusters by identifying an elbow point on one or more performance metrics for the plurality of clusters.

5. The method of claim 4 wherein the one or more performance metrics comprise at least one of a silhouette score, a sum of squared distances, and a within-cluster sum of squares.

6. The method of claim 1 wherein the one or more parameters comprise one or more designated characteristics to be included in the input dataset.

7. The method of claim 1 wherein the selecting the plurality of data points from respective ones of the plurality of clusters is based at least in part on a threshold value for a number of representative data points from each of the respective ones of the plurality of clusters.

8. The method of claim 1 wherein the selecting the plurality of data points from respective ones of the plurality of clusters comprises computing a silhouette score for respective ones of the plurality of data points.

9. The method of claim 1 wherein the identifying of the one or more features from the plurality of data points comprises executing a coefficient of variation analysis on a base set of features derived from the plurality of data points.

10. The method of claim 9 wherein the identifying of the one or more features from the plurality of data points further comprises ranking respective ones of the features from the base set based at least in part on a coefficient of variation of the respective ones of the features.

11. The method of claim 1 wherein inputting the one or more features to the machine learning language model comprises generating an input prompt for the machine learning language model, the input prompt comprising the one or more features and at least one of a standard deviation value and a mean value associated with the one or more features.

12. The method of claim 11 wherein the input prompt further comprises at least one of a cluster density value and cluster compactness value.

13. The method of claim 1 wherein the machine learning language model comprises a large language model.

14. An apparatus comprising:
a processing device operatively coupled to a memory and configured:
to receive a query comprising one or more parameters for cluster formation;
to form a plurality of clusters from an input dataset, wherein the plurality of clusters comprise respective ones of a plurality of sub-datasets of the input dataset and are based at least in part on the one or more parameters;
to select a plurality of data points from respective ones of the plurality of clusters;
to identify one or more features from the plurality of data points;
to input the one or more features to a machine learning language model; and
to execute the machine learning language model to generate a textual output based at least in part on the one or more features.

15. The apparatus of claim 14 wherein, in forming the plurality of clusters, the processing device is configured to execute one or more unsupervised machine learning algorithms on the input dataset to form the plurality of clusters.

16. The apparatus of claim 14 wherein, in identifying the one or more features from the plurality of data points, the processing device is configured to execute a coefficient of variation analysis on a base set of features derived from the plurality of data points.

17. The apparatus of claim 14 wherein, in inputting the one or more features to the machine learning language model, the processing device is configured to generate an input prompt for the machine learning language model, the input prompt comprising the one or more features and at least one of a standard deviation value and a mean value associated with the one or more features.

18. An article of manufacture comprising a non-transitory processor-readable storage medium having stored therein program code of one or more software programs, wherein the program code when executed by at least one processing device causes said at least one processing device to perform the steps of:
receiving a query comprising one or more parameters for cluster formation;
forming a plurality of clusters from an input dataset, wherein the plurality of clusters comprise respective ones of a plurality of sub-datasets of the input dataset and are based at least in part on the one or more parameters;
selecting a plurality of data points from respective ones of the plurality of clusters;
identifying one or more features from the plurality of data points;
inputting the one or more features to a machine learning language model; and
executing the machine learning language model to generate a textual output based at least in part on the one or more features.

19. The article of manufacture of claim 18 wherein, in forming the plurality of clusters, the program code causes said at least one processing device to execute one or more unsupervised machine learning algorithms on the input dataset to form the plurality of clusters.

20. The article of manufacture of claim 18 wherein, in inputting the one or more features to the machine learning language model, the program code causes said at least one processing device to generate an input prompt for the machine learning language model, the input prompt comprising the one or more features and at least one of a standard deviation value and a mean value associated with the one or more features.
